(19) United States
(12) Patent Application Publication
(10) Pub. No.: US 2003/0225777 A1
(43) Pub. Date: Dec. 4, 2003

(54) Scoring and recommending media content based on user preferences

(76) Inventor: David J. Marsh, Sammamish, WA (US)

Correspondence Address: LEE & HAYES PLLC, 421 W RIVERSIDE AVENUE SUITE 500, SPOKANE, WA, 99201

(21) Appl. No.: 10/160,932

(22) Filed: May 31, 2002

(51) Int. Cl. G06F 7/00

(52) U.S. Cl. 707/101

(57) ABSTRACT

Systems and methods are described for scoring and accurately recommending multimedia content programming to users based upon a user's preferences, each user receiving individualized programming recommendations according to that user's likes and dislikes. A user provides preferred values for attributes of television programs. For example, if the user likes reality shows, the user would assign a relatively high attribute score for a genre attribute having a value of ‘reality show.” The preferred values are compared to a program description file that list program attribute values for a program available for viewing. A program score is obtained based on this comparison. If there are many matches, then the program score will be high. Programs are recommended to the user based on the program scores of the programs; programs having higher program scores (from having many matches with the user's preferences) will be recommended over lower-scoring programs.

### TECHNICAL FIELD

The systems and methods described herein relate to personalizing multimedia programming for particular viewers. More particularly, the system and methods described herein relate to scoring and recommending media content such as television programs to a user based on the user's likes and/or dislikes.

### BACKGROUND

In today's television-watching world with hundreds of television channels, it is extremely hard for viewers to find the television program that they will most enjoy. Current electronic programming guides (EPG) provide a daunting sea of information and it would take several hours to look through it all. Many viewers just look at a few favorite channels to see what's on, but this means that they miss many programs on other channels that they would have enjoyed.

With up to five hundred channels available to many television viewers today, it is too impractical for a user to spend the time necessary to manually search through page after page of program listings to find something the user might want to watch. If the user were to take the time to do a proper job of this, there would be no time left for actual program viewing. In practice, viewers today just look at a few favorite channels out of the hundreds that are available. Unfortunately, this means that they are missing out on many programs they would have enjoyed. Many viewers who do not want to take the time to look at program information guides essentially give up on using an EPG and revert to channel surfing.

What the viewer really wants when they sit down in front of the television after a hard day's work is to see a list of only about ten programs from which to choose, where each of the programs accurately matches with the likes and desires of that particular viewer. These accurate recommendations will have been automatically generated by the system and, in some cases, automatically recorded by the system for viewing at the user's leisure.

There are systems that exist that attempt to produce television programming recommendations but, in practice, most users turn off the feature because the recommendations generated do not accurately match with what the viewer really wants to watch. An automatic system that does not work properly is more of an annoyance than help. If the recommendations can be made accurately, then they will be very useful to viewers.

### SUMMARY

Systems and methods are described for scoring and accurately recommending multimedia content programming to users based upon a user's preferences, each user receiving individualized programming recommendations according to that user's likes and dislikes. This involves matching values for program attributes that a user likes with values of attributes of programs that are offered, for example in an upcoming television schedule.

The first step in automating the finding of television programs is to inform a system as to what types of programs a particular viewer likes to watch. In the present invention, program attribute values that a user enjoys in a program are stored in a User Preference File (UPF) associated with the user. Initially, the user inputs information about such attribute values, such as by completing a series of questions provided by a viewing system. Thereafter, the system monitors the user's viewing habits to determine what kinds of programs the user watches, the attribute values of the programs, how long the user watches each program, etc., and builds a user viewing log. At certain intervals the user viewing log is utilized to update the user's UPF, thereby enriching the user's UPF with additional information over time. As a result, the recommendations become more and more accurate.

In addition to establishing user preferences, upcoming programs that are available to users must be compared against each user's preferences to determine which programs best match the preferences. In the present invention, this is accomplished by comparing content description files associated with available programs to a user's UPF. Such content description files (CDF) include program attribute values in the form of a specially designed schema. The values of the attributes in the UPF, by being arranged in the same schema as the CDFs, can easily be compared and matches can be identified between the two files.

When a match is found between a program attribute value contained in a CDF and a preference attribute value contained in a UPF, a relative value, or score, of that match is determined. In one implementation described herein, this is accomplished by including a preference rating for each attribute value in the UPF. Additionally, a significance rating that denotes a relative importance of an attribute with regard to other attributes is used to weight the scores for the matches.

The preference rating denotes how much a user values a particular attribute in a program. For example, a user who likes mysteries might assign a preference value of +5 to a mystery attribute. Likewise, if the user dislikes reality shows, the user might assign a preference value of −5 to a reality show attribute.

The significance values denote a relative importance between attributes and typically may be stored in a separate file from the UPF. For example, an attribute that designates a particular actor might have a higher significance value than an attribute that designates whether a program has stereo or surround sound.

When a match is found between a CDF attribute and a UPF attribute, an attribute score is derived by multiplying the preference rating for the attribute by the significance value for the attribute. A program score associated with a program is derived by adding the attribute scores attained derived with regard to the program.

When each available program has been assigned a score, programs are recommended to a user. In one implementation, recommended programs are recorded so that the user may view them at any later time. Programs that attain program scores greater than a predetermined threshold score may qualify for recommendation if disk space is not at a premium.

Available storage space may be taken into account when determine which programs to recommend or record. If a program score is greater than the threshold score and there is storage space available in a content buffer (to store either the program itself or the program description or both), then the program is stored. If a program score is greater than the threshold score and there is no available storage space, the program score is compared to program scores of programs already stored in the program buffer. If the program score is higher than one or more program scores of programs stored in the program buffer, then the lowest scored program or programs in the program buffer is/are deleted and the new program is stored.

A major advantage of the systems and methods described herein concerns a user's privacy. All preference data related to a user is contained on the client and no such information is sent to the server. Additionally, in one implementation, a user can have more than one user preference file (UPF) to help guard privacy. Also, a user is always able to view and edit the content of their particular one or more UPFs.

### BRIEF DESCRIPTION OF THE DRAWINGS

A more complete understanding of exemplary methods and arrangements of the present invention may be had by reference to the following detailed description when taken in conjunction with the accompanying drawings wherein:

FIG. 1 is a block diagram of a system constructed in accordance with the present invention.

FIG. 2 is a representation of an example of a user preference file with attributes and attribute values.

FIG. 3 is a representation of an example of a content description file with attributes and attribute values.

FIG. 4 is a representation of an example of a significance file with attributes and significance values.

FIG. 5 is a flow diagram depicting a methodological implementation of creation and maintenance of a user preference file.

FIG. 6 is a flow diagram depicting a methodological implementation of scoring and recommending programming to a user based on metadata matching techniques.

FIG. 7 is a diagram of an exemplary system on which the present invention may be implemented.

### DETAILED DESCRIPTION

This invention concerns systems and methods for scoring and recommending television programming and/or multimedia content to a user based on the user's preferences. A user preference file (UPF) is constructed and maintained to store a user's viewing preferences. The UPF is constructed according to a schema by which available programming is described in one or more content description files (CDF). A CDF for an available program is compared to the user's UPF. Any matches between the two files are scored to derive a program score. If the program score is greater than a predefined threshold, then the program is a candidate for recommendation to the user.

Exemplary Environment

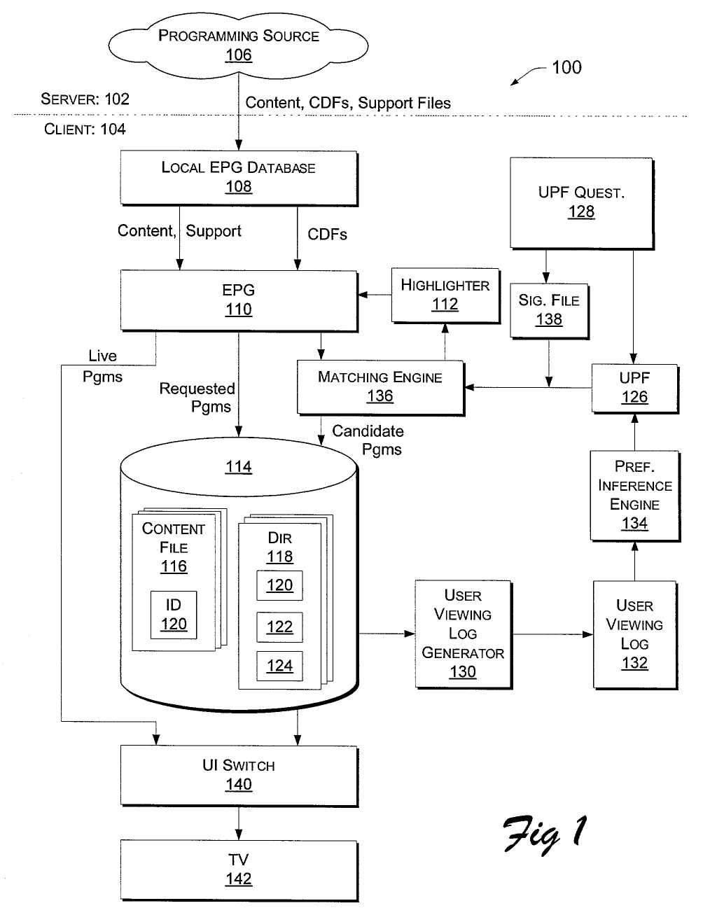

FIG. 1 is a block diagram depicting a user preference recommendation system environment 100 (hereinafter “environment”) for scoring programs available for viewing according to a user's preferences and recommending certain programs that meet one or particular conditions. The environment 100 includes a server 102 and a client 104, although there may be several clients (not shown) connected to the server 102 via a network (not shown) such as the Internet. The server 102 includes a content programming source 106 that transmits content programs to the client 104. The content programs may be transmitted according to any suitable protocol known in the art.

The client 104 includes a local electronic programming guide (EPG) database 108 that stores content files, support files and content description files associated with the content files that are downloaded from the programming source 102. The EPG database 108 provides data to an electronic programming guide (EPG) 110. The EPG 110 is similar to those known in the art in that it displays program names, dates, times, lengths, etc. in a grid-like user interface. However, as will be discussed below, the EPG 110 and the information available via the EPG 110 is unique in several respects. A highlighter 112 highlights particular programs displayed on the EPG 110, the highlighter 112 being a function of a viewer's likes and dislikes.

The client 104 also includes a content buffer 114 that stores at least one content file 116 that contains a multimedia program, such as a television program. Each content file 116 has a directory 118 associated with it by means of a content identifier 120. The content identifier 120 is a value that uniquely identifies the content file 116 and its associated directory 118.

In one implementation, the content identifier 120 is a MICROSOFT Content Identifier (MCID). The MCID is a structured numbering scheme able to separately identify the series, episode, version and broadcast part of a content file or transmission. Significant software is involved in the number allocation process to ensure that the same number is used to identify repeated content and to ensure that individual program episodes are correctly grouped into a series in which they belong.

Each directory 118 stores a content description file (CDF) 122 that describes content contained in the content file 116 associated with the directory 118. The content description file conforms to a content description schema that standardizes content descriptions. The directory 118 may also store one or more support files 124 that contain data that may be required by the content file 116 such as artwork or the like.

The client 104 includes a user preference file (UPF) 126 that is associated with a user of the client 104. The client 104 may contain more than one UPF 126 for each user and/or one or more UPFs 126 for each of one or more other users.

The UPF 126 stores values for attributes of multimedia content eg TV programs, each attribute value having a preference value associated with it that indicates how much the user associated with the UPF 126 likes or dislikes that particular attribute value in a program. The UPF 126 also conforms to the content description schema that is used in the CDF 122 to describe content.

The UPF 126 is an important element that allows separation of the process of establishing user preference from the process of matching the user preferences with programs that are available for viewing. The UPF 126 provides the decoupling of the two processes.

There are various techniques that can be used to populate the UPF 126 with useful information, i.e., information about what attribute values of television programs are liked and which are specifically disliked. One way to produce a UPF 126 is to provide the user with a UPF questionnaire 128 and ask the user directly about what attribute values are important to the user.

After the UPF 126 is initially constructed, the UPF 126 is periodically updated with new information about preferred program attribute values. In one implementation, the user may recall the UPF questionnaire 128 and add additional information. Also, the UPF 126 is preferably an editable file that a user may access to edit entries, or attributes.

A more advanced technique is described that provides a user viewing log generator 130 that monitors programs watched (or listed to or otherwise consumed) by the user. Program attribute values associated with the monitored programs together with the time for which each attribute was viewed are logged in a user viewing log 132. At predetermined intervals, a preference inference engine 134 builds up the UPF 126 using information contained in the user viewing log 132.

For example, the user viewing log generator 130 may log a program only if the program is watched for a certain amount of time, such as for twenty minutes. After that time, the user viewing log generator 130 may consider the program significant and log program attribute values of the program, such as the genre of the program, the actors starring in the program, the program title, etc. The preference inference engine 134 analyzes the data collected in the user viewing log 132 and determines which information should be used to update the UPF 126 as preferred attribute values.

As previously mentioned, in one implementation, the preference inference engine 134 periodically updates the UPF 126 at predefined intervals. In another implementation, the preference inference engine 134 updates the UPF 126 when a certain amount of data has been collected in the user viewing log. This way, if the user's viewing habits are such that an unusually large amount of data is logged in a short period of time, the data can be parsed and integrated into the UPF 126 before the size of the data becomes large and unwieldy. The resources required by the preference inference engine should not be so great as to draw essential resources for presenting the programs to the user.

In the present implementation, both techniques described above are used. The UPF questionnaire 128 is initially used to create the UPF 126. Thereafter, the preference inference engine 134 continually enriches the information stored in the UPF 126. As more detail is accumulated in the UPF 126, recommendations made based on the UPF 126 will be more accurate, i.e., the recommendations provided to the user will more closely satisfy the user's preferences.

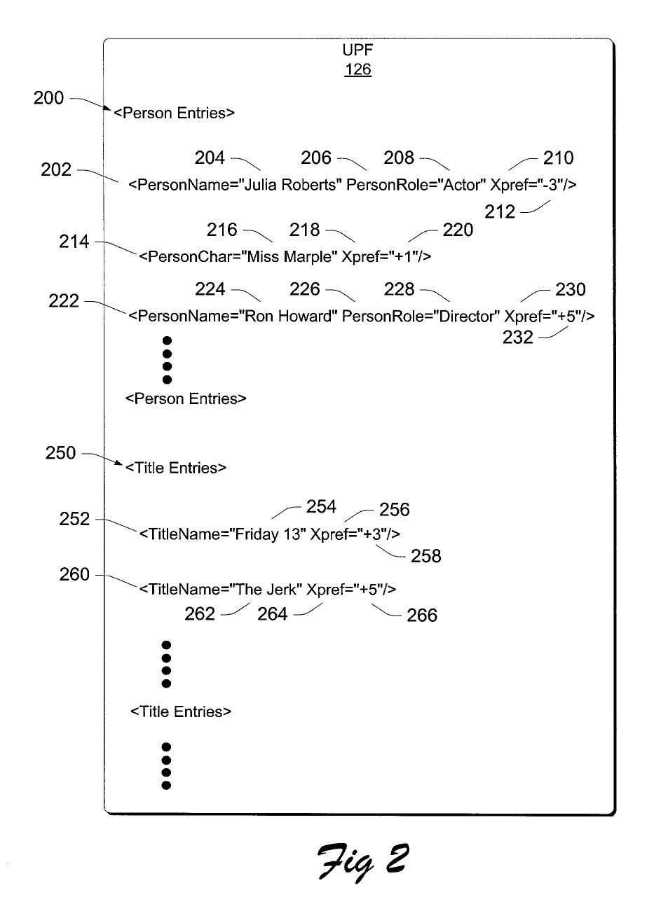

The client 104 also includes a matching engine 136 that drives the comparison of a UPF with content description files associated with programs that are available for viewing. When the matching engine 136 determines that an attribute value in the UPF 126 matches an attribute value found in a CDF 116, the matching engine 136 calculates an attribute score for the matching attribute, i.e., the attribute that has matching values in the UPF 126 and the CDF 116. For example, an “actor” attribute in the UPF 126 may contain a value of “Steve Martin.” If an “actor” attribute in the CDF 116 also contains the value of “Steve Martin,” then the “actor” attribute is referred to herein as a matching attribute. An attribute score may then be assigned to the matching attribute and one or more attribute scores assigned in a program are used to calculate a program score for the program. In one implementation, significance values included in a significance file 138 are utilized in the calculation of program scores. Programs may then be recommended to users based on program scores associated with the programs. Attribute scores and program scores will be discussed in greater detail below, in the discussion of FIGS. 2-4, which further describes the UPF 126, the CDF 116, the significance file 138 and the content description schema utilized therein.

The client 104 also includes a user interface (UI) switch 140 and a television 142. Although shown as being a part of the client 104 in this example, it is noted that the television 142 may be separate from the client 104, such as in the case where the client 104 is embodied in a set top box (STB). The UI switch 140 is used to switch between stored programs in the content buffer 114 and live programs emanating from the content source 106.

Content Description Schema

In order to match the attribute values that the user likes with the attribute values of the content programs (e.g., movies, television programs, audio programs, etc.), it is necessary to have a comprehensive and consistent way to describe content. In the present invention, content is described according to a content description schema that includes metadata categories corresponding to content attributes. The content description schema used herein is similar to the content description schema described in U.S. patent application Ser. No. 10/125,260, entitled “Media Content Description” by David J. Marsh, filed Apr. 16, 2002, and assigned to the MICROSOFT CORP., the assignee of the present invention. That patent application is incorporated herein by reference.

User Preference File

FIG. 2 is a representation of an example of the content description schema as used in the user preference file 126. The example contains an abbreviated selection of attributes and attribute values, and it is noted that there may be more entries than shown and/or different attributes and/or attribute values than shown in FIG. 2.

Preferably, the UPF 126 is written in terms of the same metadata attributes, i.e., categories, that are used to describe the content on offer in upcoming multimedia programs, described here as being contained in the CDF 122. A separate but compatible schema could be used for the UPF 126 and the CDF 122, but as a content description schema is an evolving concept with additional metadata categories being added over time, it is hard to keep separate schemas in synchronization with each other. A better approach is to architect the content description schema so that the same schema can be used for both the content description file and the user preference file, as is described herein.

To facilitate the inclusion of the content description schema within the UPF schema and to ensure the two remain in synch, certain ‘user preference’ attributes are added to the content description schema that is defined in the previously incorporated application. One added attribute is a preference rating that a user assigns to a particular metadata entry. Another added attribute is a significance value that denotes a relative importance of the attribute to which it corresponds. These attributes will be discussed in greater detail below.

The UPF 126 includes a section having a “Person Entries” heading 200 and a section having a “Title Entries” heading 250. The “Person Entries” 200 heading includes a “Person Name” attribute 202 that is used to identify an actor preferred by a user. A Person Name attribute value 204 contains an actor's name, “Julia Roberts.” This indicates that the user corresponding to the UPF 126 has a preference—liking or disliking—for Julia Roberts starring in a program.

A “Person Role” attribute 206 is included to identify a particular function that the person identified in the Person Name attribute value 204 performs in the program. This allows a user to distinguish between actors who may also be a director in some programs. For example, the user may like movies that Clint Eastwood stars in but not movies that Clint Eastwood directs. In the present example, the “Person Role” attribute 206 has a Person Role attribute value 208 that indicates that the user is referring—in this entry—to Julia Roberts as an actor and not as a director, producer, or otherwise

A preference attribute 210 is associated with a preference rating 212 that the user enters to indicate how much, relatively, the user likes or dislikes the values specified in the “Person Name” attribute 202. The preference attribute 210 is an attribute added to the content description schema described in the previously incorporated patent application. The preference rating 212 in the present example implementation may range from a negative five to a positive five—negative denoting a dislike for an associated attribute, positive denoting a liking of an associated attribute. However, the range of values of the preference value 212 depends on the implementation. In this example, the preference rating 212 is “−3”, which indicates that the user prefers programs in which Julia Roberts does not star.

The UPF 126 also includes a “Person Character” attribute 214, a Person Character attribute value 216 and a preference attribute 218 and preference rating associated with the “Person Character” attribute 214. The “Person Character” attribute 214 enables a user to identify particular characters that the user likes or dislikes. In the present example, the Person Character attribute value 216 is “Miss Marple” and the preference rating associated with that character is “+1”, which indicates that the user slightly prefers programs in which this character appears.

There may be virtually any number of similar entries under the “Person Entries” heading 200. Also shown in FIG. 2 is a “Person Name” attribute 222 having a Person Name attribute value 224 of “Ron Howard.” A Person Role attribute 226 associated with the “Person Name” attribute 222 includes a Person Role attribute value 228 of “Director.” A preference attribute 230 has a preference rating 232 of “+5”. This indicates that the user associated with the UPF 126 strongly prefers programs directed by Ron Howard. Note that it does not indicate any preference for TV programs or movies where Ron Howard is an actor.

Under the “Title Entries” heading 250 is a “Title Name” attribute 252 having a Title Name attribute value 254 of “Friday 13” associated with it. A preference attribute 256 has a preference rating 258 of “+2” and thus indicates that the user mildly prefers the “Friday the 13^{th}” series of movies.

Whether attribute values actually match or not depends on the particular entry type. In the case of a preference for a movie sound track to be in French, a complete match is looked for. In the case of other element types, a more subtle correspondence between attribute values may constitute a match. In the above example of a title entry, it is not necessary to have a complete match for a match to have been deemed to be present. It is only necessary for the words from the Title Name attribute value 254 in the UPF 126 to appear somewhere in the content title for a match to be triggered. The above example—“Friday 13”—would match with any of the “Friday the 13^{th}” series of movies.

The “Title Entries” heading 250 section may contain any number of entries, In the present example, another “Title Name” attribute 260 is included and has a Title Name attribute value 262 of “The Jerk.” A preference attribute 264 has a corresponding preference rating 266 of “+5” indicating that the user really likes that particular movie.

Content Description File

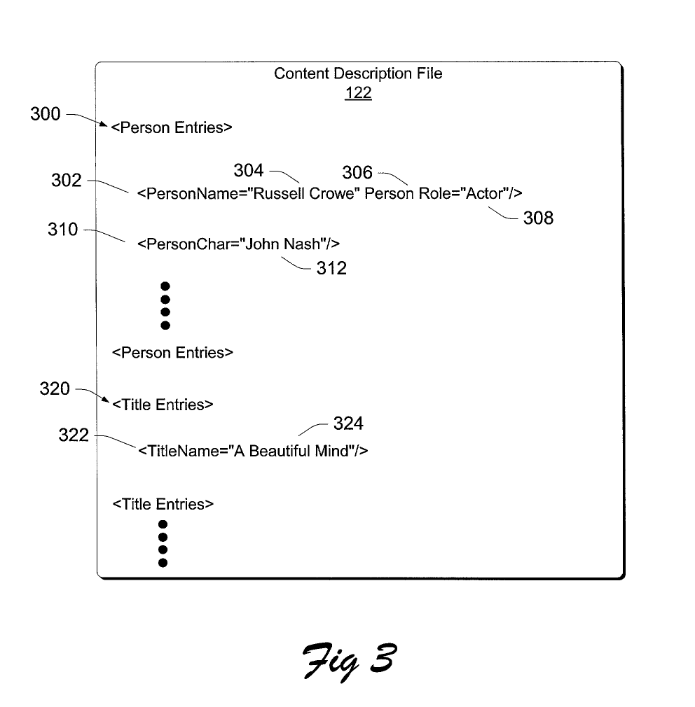

FIG. 3 is a representation of an example of the content description file (CDF) 122 shown and described in FIG. 1. The CDF 122 shown in FIG. 3 is exemplary only and has been simplified for presentation. It is noted that entries or attributes included in the CDF 122 may include more than what is shown in FIG. 3. For example, a title entry may include an entry index, a content identifier, a date of release, a running time, a language, and the like.

The CDF 122 includes “Person Entries” heading 300 and a “Title Entries” heading 320. A “Person Name” attribute 302 under the “Person Entries” heading 300 identifies a person associated with the program that corresponds with the CDF 122. In this example, the “Person Name” attribute 302 is associated with a Person Name attribute value 304 of “Russell Crowe” which indicates that Russell Crowe is associated with the program corresponding to the CDF 122.

A “Person Role” attribute 306 identifies a function performed by the person identifies in the Person Name attribute value 304. Here, a Person Role attribute value 308 associated with the “Person Role” attribute 306 is “Actor” meaning that Russell Crowe is an actor in the described program.

A “Person Character” attribute 310 is used to identify a character in the program described by the CDF 122. In this example, the “Person Character” attribute corresponds with a Person Character attribute value 312 of “John Nash,” indicating that one character in the described program is John Nash. It is apparent that a “Person Name” attribute 302 may be present in the CDF 122 for each person associated with the program (e.g., actor, director, producer, etc.). Also, a “Person Character” attribute 310 may be included for each character that appears in the program.

A “Title Name” attribute 322 under the “Title Entries” heading 320 identifies a title of the program associated with the CDF 122. In this example, the “Title Name” attribute 322 contains a Title Name attribute value 324 of “A Beautiful Mind,” that being the title of the program.

It can be seen that the UPF 126 and the CDF 122 contain the same—or at least many of the same—attributes. This is due to the fact that the files utilize the same content description schema to describe attributes of programs. This makes the process of matching program attributes with a user's preferred attributes much more straightforward.

Significance File

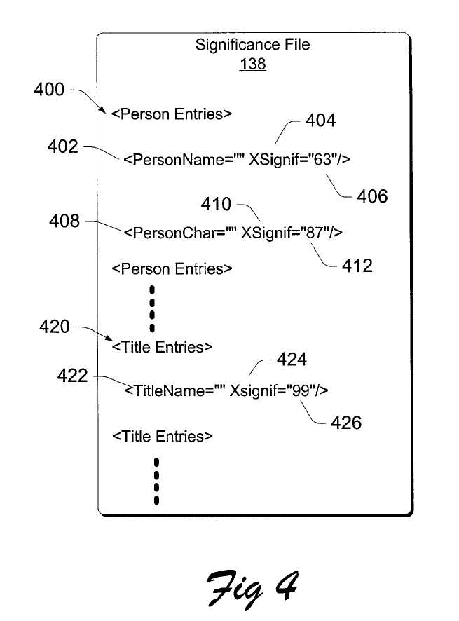

FIG. 4 is a representation of an example of the significance file 138 shown in FIG. 1. The significance file 138 is used to stored significance values that correspond to each attribute available in a program. Each significance value denotes a relative importance of the attribute with which it corresponds as compared to the other attributes. Use of the significance values provides an appropriate weighting factor when determining whether a program should be recommended to a user or not.

An example of the use of significance values is that a particular actor starring in a program is more important to a user than whether the program is in surround sound. Although a user may enter a same preference value for a Person Name attribute value and a Surround Sound attribute value (e.g., +5) because the user strongly prefers both, all other things being equal, by using the significance file the system would determine that a user would prefer a program having the particular actor and stereo sound to a program without the actor but with surround sound. To appropriate weight this consideration, significance values are assigned to each attribute.

The significance file 138 includes a “Person Entries” heading 400 and a “Title Entries” heading 420. Note that these entries are similar to the entries contained in the UPF 126 and the CDF 122. Also, it should be noted that many other types of entries may be included in the significance file 138, but only a few are shown in this example.

A “Person Name” attribute 402 is included under the “Person Entries” heading 400. Associated with the “Person Name” attribute 402 is a significance attribute 404 that is used to identify the relative importance of a person being associated with a program as compared to other attributes. In this implementation example, a significance value of “63” has been assigned to the “Person Name” attribute 402. If the significance values range from zero to one hundred, a “63” value indicates that it is fairly important to the user that a “Person Name” attribute in the CDF 122 match a “Person Name” attribute in the user's UPF 126. The value range is arbitrary and, of course, must include a range that contains as many elements as there are attributes.

A “Person Character” attribute 408 is also listed under the “Person Entries” heading 400. The “Person Character” attribute 408 enables a user to rate the significance of a particular character being in a program available for viewing. A significance attribute 410 associated with the “Person Character” attribute 408 contains a significance value 412 of “87.” This indicates that the presence of a particular character in a program is very important to the calculation of the program score. As compared to the significance value 406 for the “Person Name” attribute 402, it can be seen that it is more important that a particular character be in a program than it is for a particular person to star in or be otherwise associated with the program.

A “Title Name” attribute 422 is included under the “Title Entries” heading 420. The “Title Name” attribute 422 allows a user to indicate how important it is—as far as program recommendation is concerned—for a program title to match a title stored in the user's UPF 126. In the present example, a significance attribute 424 contains a significance value 426 of “99,” indicating that it is very important to a program's recommendation score if the program title matches a title in the user's UPF 126.

It is noted that the significance values could be stored in the UPF 126 along with each entry therein. However, this would require redundant entries since some attributes may be repeated with different attribute values. For example, a UPF 126 may include fifty actors' names that a user prefers to see. If the significance values were included in the UPF 126, then each of the fifty entries for actors' names would have to include the same significance value. It is best if the Significance file is a system wide global file that relates to all users.

Furthermore, it is noted that it is not necessary that the user create and/or have control over the significance file. A content provider may assign the significance values for a system. While such an implementation would not provide as close a fit with each user's personal preferences, it would relieve the user from having to do the work himself. Preferable, a system is shipped with default significance values that may be changed by a user.

Methodological Implementation: Content Description File

FIG. 3 is a flow diagram depicting a methodological implementation of content description file creation and usage. In the following discussion, continuing reference will be made to the elements and reference numerals shown in previous figures.

Methodological Implementation: UPF Creation and Maintenance

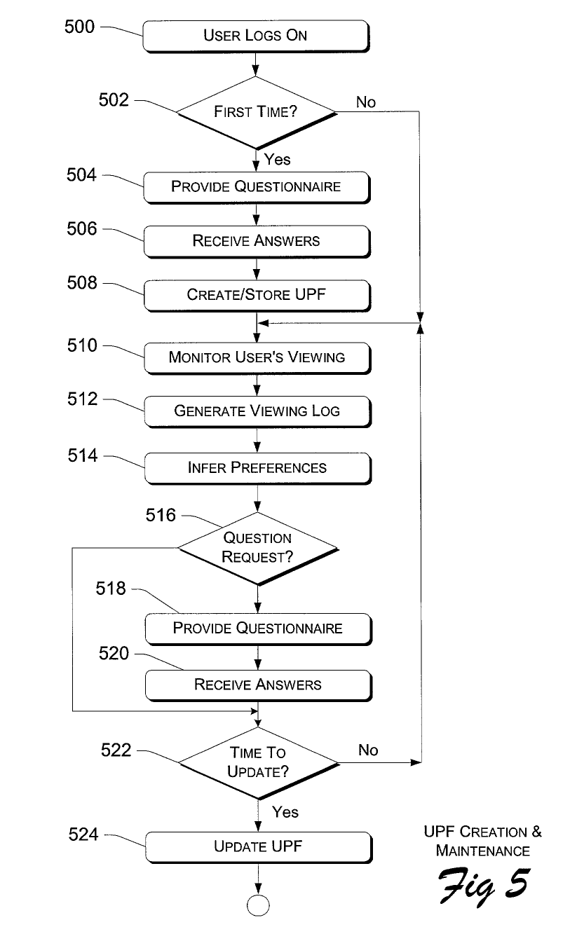

FIG. 5 is a flow diagram depicting a methodological implementation of creation and maintenance of a user preference file (UPF). In the following discussion, reference will be made to the elements and reference numerals included in FIG. 1. At block 500, a user logs on to a viewing system equipped with appropriate equipment for providing program recommendations to the user. If it is the user's first time to be on the system (“Yes” branch, block 502), then the user is provided a questionnaire at block 504 that requests information about program attributes and values for the attributes that the user likes or dislikes. Answers to the questionnaire are received (block 506) and are stored to create the user preference file at block 508. If it is not the user's first time to be on the system (“No” branch, block 502), then blocks 504-508 are skipped, as the user already has a UPF associated with him or her.

At block 510, the user's viewing habits are monitored. Some things that might be monitored for programs viewed include, but are not limited to, the length of time that the program is watched, actors/directors/producers in the programs, characters in the programs, genre of the programs, names of the programs, etc.

The user viewing log generator 130 generates the user viewing log 132 from the monitored data (block 512). The preference inference engine 134 analyzes the user viewing log 132 at block 514 to determine if one or more new user preferences (i.e., user preferences not already stored in the UPF 126) can be discovered.

In addition to determining new user preferences by the preference inference engine 134, the user may, from time to time, request a questionnaire to update the user's UPF 126. If the user makes such a request (“Yes” branch, block 516), then the user is provided with a questionnaire at block 518 and answers to the questionnaire are received at block 520. If the user does not request a questionnaire (“No” branch, block 516), then block 518 and block 520 are omitted.

At block 522, it is determined whether it is time to update the UPF 126. This may be determined according to one or more of several factors. The UPF 126 may be updated at certain predefined time intervals, such as every day, week, month, etc. The UPF 126 may also be updated when the user provides new answers to a questionnaire. Additionally, the preference inference engine 134 may wait until a certain number of new preferences can be determined and update the UPF 126 when that number has been attained.

If it is time to update the UPF 126 under any one of the above conditions, then the UPF 126 is updated by adding the new user preferences to the user preferences already stored in the UPF 126 (block 524). If it is not time to update the UPF 126, then the process reverts to block 510, where the user's viewing habits are monitored.

By making provisions to update the UPF 126, a user can be assured that the programs recommended will become more and more accurate to the user's liking over time, as the UPF 126 becomes more and more enriched. This is because a greater number of user preferences that can be attributed to a user means that the likelihood of matching preferred programs is greatly increased. As a practical matter, it would be unusual for a user to take the time to fill out every preference at one time. Also, it would be difficult for a user to think of all of her preferences on one occasion, when the questionnaire is being completed. Therefore, it is preferable to start with as many preferences as possible, and add to them over time.

Methodological Implementation: Metadata Scoring/Recommendation

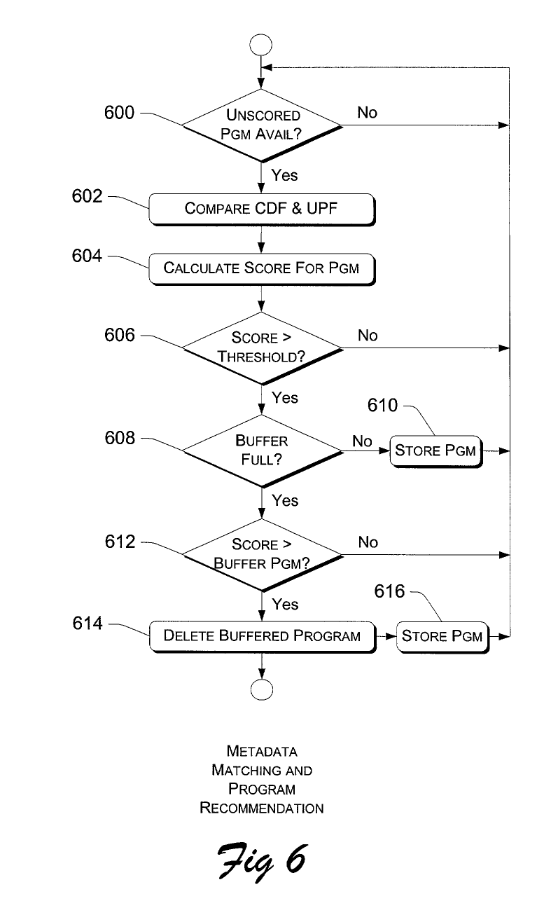

FIG. 6 is a flow diagram depicting a methodological implementation of metadata matching and program recommendation. In the following discussion, reference will be made to the elements and reference numerals included in FIG. 1.

At block 600, it is determined if there are programs available for user viewing that have not been scored. Each program candidate for recommendation is assigned a program score and the program is recommended or not based on the program score. Details of obtaining the program scores will be discussed in detail below.

As long as there is not an unscored program available for viewing (“No” branch, block 600), the process holds until one or more such programs become available. If there is at least one program available that has not been scored (“Yes” branch, block 600), then the matching engine 138 compares the UPF 126 associated with the user and the CDF 122 associated with the program at block 602. In this step, the matching engine 138 is configured to compare each preferred attribute value stored in the UPF 126 with each program attribute value stored in the CDF 122. When an attribute having the same value in the UPF 126 and the CDF 122 is detected, the matching engine 138 assigns an attribute score to the attribute.

The attribute score assigned to the attribute is the preference rating 212, 220, 232, 258, 260 associated with the attribute in the UPF 126, i.e., the preference rating assigned by the user for the attribute value of the matched attribute. An attribute score is assigned for each attribute having a value that matches between the UPF 126 and the CDF 122. Accordingly, there can be from zero to several attribute scores for a particular program.

At block 604, the matching engine 138 calculates a program score for the program being evaluated. The program score is derived by first weighting each of the attribute scores with the significance value 406, 412, 426 that corresponds with the attribute. The weighted attribute scores are then added to derive the program score.

The program score is compared against a threshold score to determine if the program should be recommended. If the program score is less than the threshold score (“No” branch, block 606), then the program is not recommended and the process reverts to block 600 to find another program to score.

If the program score is greater than the threshold score (“Yes” branch, block 606), then a determination is made as to whether the content buffer 114 has sufficient storage space available to store the program. In one implementation, the content buffer 114 is used to store recommended programs. In another implementation, the content buffer 114 stores only program information, such as the CDF 122 and any information needed to inform the user that a program is recommended and to provide the user with a detailed description of the program.

In the present example, if the content buffer 114 has sufficient storage space available to store the program (“No” branch, block 608), then the program is stored at block 610 and the process reverts to block 600 to score another available program. If the content buffer 114 is full (“Yes” branch, block 608), then program scores associated with programs stored in the content buffer 114 are compared against the program scored of the evaluated program. If there is no stored program that has a lower program score than the evaluated program (“No” branch, block 612), then the process reverts to block 600 to score another candidate program.

If, however, there is a stored program that has a lower program score than the evaluated program (“Yes” branch, block 612), then the stored program is deleted at block 614 and the evaluated program is stored in the content buffer 114 at block 616. If deletion of the stored program does not free up enough memory in the content buffer 114 to store the evaluated program, then block 612 must be performed again to find another program that can be deleted to make room to store the evaluated program.

Using this technique, only the programs receiving the highest program scores will be stored in the content buffer 114 and, thus, will be recommended to the user.

It is noted that, in one implementation, the process simply recommends programs that receive higher program scores than the scoring threshold. This may be the case in the event that the size of the content buffer 114 is not a viable problem. In another implementation, the scoring threshold may not be used, and the only condition required to recommend the program is that it have a higher score than one or more programs already stored in the content buffer 114. Any of the described implementations will provide the user with an accurate program recommendation source and will free the user from spending an inordinate amount of time browsing an EPG to find programs preferable to the user.

Note too that time is another important factor in determining storage space usage. Initially programs are stored in the content buffer as record requests. Only a very small amount of storage space is needed for this. When at some future time the TV program is actually broadcast and recorded by the client, the amount of storage space needed for that media item goes up dramatically because of the actual stored video. It is therefore ok to store record requests without compromise, provided the disk space allocations decisions are performed immediately before the actual broadcast time.

Exemplary Computer Environment

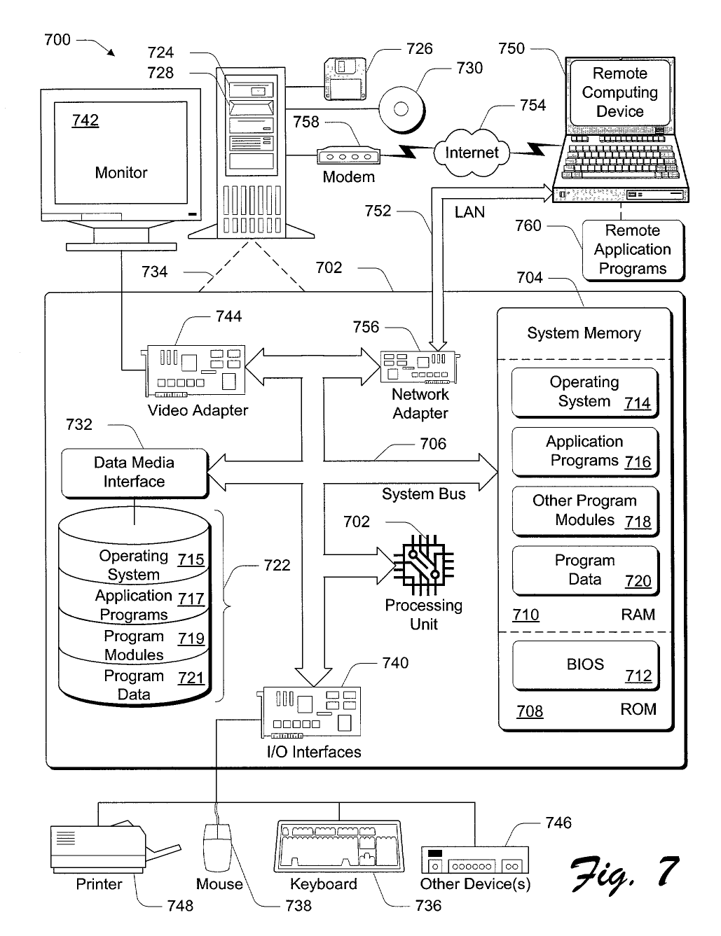

The various components and functionality described herein are implemented with a number of individual computers. FIG. 7 shows components of typical example of such a computer, referred by to reference numeral 700. The components shown in FIG. 7 are only examples, and are not intended to suggest any limitation as to the scope of the functionality of the invention; the invention is not necessarily dependent on the features shown in FIG. 7.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 7, the components of computer 700 may include, but are not limited to, a processing unit 702, a system memory 704, and a system bus 706 that couples various system components including the system memory to the processing unit 702. The system bus 706 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 700 typically includes a variety of computer-readable media. Computer-readable media can be any available media that can be accessed by computer 700 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 700. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 704 includes computer storage media in the form of volatile and/or nonvolatile memory such as read only memory (ROM) 708 and random access memory (RAM) 710. A basic input/output system 712 (BIOS), containing the basic routines that help to transfer information between elements within computer 700, such as during start-up, is typically stored in ROM 708. RAM 710 typically contains data and/or program modules that are immediately accessible to and/or presently being operated on by processing unit 702. By way of example, and not limitation, FIG. 7 illustrates operating system 714, application programs 716, other program modules 718, and program data 720.

The computer 700 may also include other removable/non-removable, volatile/nonvolatile computer storage media. By way of example only, FIG. 7 illustrates a hard disk drive 722 that reads from or writes to non-removable, nonvolatile magnetic media, a magnetic disk drive 724 that reads from or writes to a removable, nonvolatile magnetic disk 726, and an optical disk drive 728 that reads from or writes to a removable, nonvolatile optical disk 730 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 722 is typically connected to the system bus 706 through a non-removable memory interface such as data media interface 732, and magnetic disk drive 724 and optical disk drive 728 are typically connected to the system bus 706 by a removable memory interface such as interface 734.

The drives and their associated computer storage media discussed above and illustrated in FIG. 7 provide storage of computer-readable instructions, data structures, program modules, and other data for computer 700. In FIG. 7, for example, hard disk drive 722 is illustrated as storing operating system 715, application programs 717, other program modules 719, and program data 721. Note that these components can either be the same as or different from operating system 714, application programs 716, other program modules 718, and program data 720. Operating system 715, application programs 717, other program modules 719, and program data 721 are given different numbers here to illustrate that, at a minimum, they are different copies. A user may enter commands and information into the computer 700 through input devices such as a keyboard 736 and pointing device 738, commonly referred to as a mouse, trackball, or touch pad. Other input devices (not shown) may include a microphone, joystick, game pad, satellite dish, scanner, or the like. These and other input devices are often connected to the processing unit 702 through an input/output (I/O) interface 740 that is coupled to the system bus, but may be connected by other interface and bus structures, such as a parallel port, game port, or a universal serial bus (USB). A monitor 742 or other type of display device is also connected to the system bus 706 via an interface, such as a video adapter 744. In addition to the monitor 742, computers may also include other peripheral output devices 746 (e.g., speakers) and one or more printers 748, which may be connected through the I/O interface 740.

The computer may operate in a networked environment using logical connections to one or more remote computers, such as a remote computing device 750. The remote computing device 750 may be a personal computer, a server, a router, a network PC, a peer device or other common network node, and typically includes many or all of the elements described above relative to computer 700. The logical connections depicted in FIG. 7 include a local area network (LAN) 752 and a wide area network (WAN) 754. Although the WAN 754 shown in FIG. 7 is the Internet, the WAN 754 may also include other networks. Such networking environments are commonplace in offices, enterprise-wide computer networks, intranets, and the like.

When used in a LAN networking environment, the computer 700 is connected to the LAN 752 through a network interface or adapter 756. When used in a WAN networking environment, the computer 700 typically includes a modem 758 or other means for establishing communications over the Internet 754. The modem 758, which may be internal or external, may be connected to the system bus 706 via the I/O interface 740, or other appropriate mechanism. In a networked environment, program modules depicted relative to the computer 700, or portions thereof, may be stored in the remote computing device 750. By way of example, and not limitation, FIG. 7 illustrates remote application programs 760 as residing on remote computing device 750. It will be appreciated that the network connections shown are exemplary and other means of establishing a communications link between the computers may be used.

### CONCLUSION

The systems and methods as described thus provide a way to accurately evaluate and recommend programs to a user that the user is likely to prefer over other programs that have been culled in the process. The user is no longer faced with spending an inordinate amount of time researching available programs manually and, as a result, missing a great deal of programming. The user is also spared having to endure inaccurate recommendations that waste the user's time by having the user examine the recommendation only to find out that the recommendation is inaccurate, and then having to delete the recommendation or the program from the user's system. All in all, the techniques described herein provide a user with a more enjoyable multimedia experience.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A method, comprising:
comparing one or more user preference attribute values to one or more program attribute values associated with a multimedia program to identify one or more matches;
deriving an attribute score for each attribute for which a match is identified; and
calculating a program score from the attribute scores.

2. The method as recited in claim 1, wherein the calculating a program score further comprises calculating the program score by adding the attribute scores derived for the multimedia program.

3. The method as recited in claim 1, wherein:
the user preference attribute values are contained in a user preference file (UPF) that is uniquely associated with a user; and
the program attribute values are contained in a content description file (CDF) that is uniquely associated with the multimedia program.

4. The method as recited in claim 1, further comprising recommending a program based on program scores derived for the program.

5. The method as recited in claim 4, wherein the recommending further comprises recommending the program if a program score associated with the program is higher than a threshold score.

6. The method as recited in claim 4, wherein the recommending further comprises:
determining if there is sufficient storage space available in a content buffer that stores one or more recommended programs;
if there is sufficient memory available, storing the program regardless of the program score; and
if there is not sufficient memory available, deleting one or more stored programs having program scores lower than the program score for the program, and storing the program.

7. The method as recited in claim 1, wherein the multimedia program is a television program.

8. The method as recited in claim 1, wherein the comparing further comprises comparing each user preference attribute value with each program attribute value.

9. The method as recited in claim 1, wherein the calculating an attribute score further comprises:
identifying a preference rating associated with an attribute for which a match was found; and
assigning the preference rating as an attribute score for the attribute.

10. The method as recited in claim 1, wherein the calculating an attribute score further comprises:
identifying a preference rating associated with an attribute for which a match was identified;
identifying a significance value associated with the attribute; and
calculating the attribute score from the preference rating and the significance value.

11. The method as recited in claim 10, wherein the calculating the attribute score further comprises multiplying the preference rating by the significance value.

12. The method as recited in claim 10, wherein the preference rating ranges from −5 to +5.

13. The method as recited in claim 10, wherein the significance value ranges from 0 to 100.

14. The method as recited in claim 1, wherein the user preference attribute values and the program attribute values conform to a content description schema.

15. A method for recommending content to a user, comprising:
comparing one or more user preference attribute values that are used to describe one or more of a user's content preferences with a content description that includes one or more program attribute values;
assigning an attribute score to each user preference attribute found to have a value that matches a program attribute value;
deriving a content score from the attribute scores; and
determining whether or not to recommend the content to the user based on the attribute scores.

16. The method as recited in claim 15, further comprising storing the content in a content buffer if the content is recommended, wherein the content buffer is used to store recommended content.

17. The method as recited in claim 15, further comprising recommending content by providing a content description to the user and indicating that the content is recommended.

18. The method as recited in claim 15, wherein the deriving a content score further comprises assigning a user preference rating as an attribute score for an attribute found to have a value that matches a program attribute value, the user preference rating being assigned by the user to indicate how much the user values the attribute.

19. The method as recited in claim 15, wherein the deriving a content score further comprises:
identifying a user preference rating associated with a matched attribute, the user preference rating being assigned by the user to indicate how much the user values the matched attribute;
identifying a significance value associated with the matched attribute, the significance rating indicating a relative importance of the matched attribute to other attributes; and
scoring the matched attribute by applying a formula to the user preference rating and the significance value.

20. The method as recited in claim 19, wherein the scoring further comprises multiplying the user preference rating by the significance value to obtain an attribute score for the matched attribute.

21. The method as recited in claim 15, wherein the determining whether or not to recommend the content further comprises recommending the content if the content score is greater than or equal to a threshold score.

22. The method as recited in claim 15, wherein the determining whether or not to recommend the content further comprises:
storing the content in a content buffer if there is sufficient storage space available in the content buffer; and
if there is not sufficient memory available in the content buffer, deleting one or more stored content from the content buffer if the stored content has a lower content score than the content, and storing the content in the content buffer.

23. The method as recited in claim 15, wherein:
the user preference attribute values are defined in a user preference file (UPF) according to a content description schema; and
the content description is defined in a content description file (CDF) according to the content description schema.

24. The method as recited in claim 15, wherein the content further comprises a television program.

25. A method, comprising:
assigning a significance value to each of multiple program attributes associated with multiple content programs;
storing the significance values in a significance file; and
wherein the significance value associated with a program attribute denotes a relative importance of the program attribute as compared with other program attributes.

26. The method as recited in claim 25, wherein each program attribute has a unique significance value associated therewith.

27. The method as recited in claim 25, wherein the program attributes belong to a content description schema.

28. The method as recited in claim 25, wherein the significance values range from 0 to 100.

29. A method, comprising:
obtaining a set of user preference values that indicate program attribute values preferred by a user; and
storing the user preference values in a user preference file (UPF) that is uniquely associated with the user.

30. The method as recited in claim 29, further comprising providing a preference questionnaire to the user to obtain the set of user preferences.

31. The method as recited in claim 29, wherein the user preference values are stored in the UPF according to a content description schema.

32. The method as recited in claim 29, further comprising updating the UPF with new user preference values after the UPF has been created.

33. The method as recited in claim 32, wherein the updating occurs periodically at predefined intervals.

34. The method as recited in claim 32, wherein the updating occurs whenever the user provides the new user preference values.

35. The method as recited in claim 29, further comprising:
monitoring one or more program attributes of programs watched by the user; and
updating the UPF with at least one program attribute value of the program attributes, storing the program attribute value as a user preference.

36. The method as recited in claim 35, further comprising:
creating a user viewing log that stores program attribute values of the monitored program attributes; and
wherein the updating further comprises periodically updating the UPF with the program attribute values stored in the user viewing log.

37. A system, comprising:
a user preference file (UPF) uniquely associated with a user, the UPF storing one or more user preferences indicated by preference attribute values associated with program attributes of one or more programs;
a matching engine configured to:
compare the user preferences with program attribute values contained in a content description file (CDF), the program attribute values describing a program uniquely associated with the CDF;
identify program attributes having program attribute values in the CDF that match a preference attribute value in the UPF;
assign an attribute score to each program attribute having matching values in the CDF and the UPF; and
compute a program score for the program associated with the CDF, the program score being computed from the attribute scores.

38. The system as recited in claim 37, wherein the matching engine is further configured to recommend the program to the user if a recommendation condition is satisfied.

39. The system as recited in claim 38, wherein the recommendation condition further comprises the program score being equal to or greater than a threshold score.

40. The system as recited in claim 38, further comprising a content buffer for storing recommended programs, and wherein the recommendation condition further comprises the content buffer having sufficient storage space available to store the program.

41. The system as recited in claim 40, wherein the matching engine is further configured to delete one or more stored programs from the content buffer when there is insufficient memory available to store the program, if the program has a higher program score than the stored programs.

42. The system as recited in claim 37, further comprising a user preference file questionnaire that is presented to the user to provide user preference information for the UPF.

43. The system as recited in claim 37, further comprising a user viewing log generator configured to monitor programs viewed by the user and store program attribute values of the monitored programs in a user viewing log.

44. The system as recited in claim 43, further comprising a preference inference engine configured to determine new user preferences from the user viewing log and to update the UPF with the new user preferences.

45. The system as recited in claim 37, wherein the matching engine is further configured to compute the program score by summing the attribute scores derived for the program.

46. The system as recited in claim 37, wherein the matching engine is further configured to assign an attribute score by identifying a preference rating assigned to an attribute for which a matching value has been identified, and to assign the preference rating as the attribute score.

47. The system as recited in claim 37, further comprising a significance file that contains a significance value for each program attribute available for a program, and wherein the matching engine is further configured to:
assign an attribute score by identifying a preference rating assigned to an attribute for which a matching value has been identified, and to assign the preference rating as the attribute score; and
compute a program score from the attribute score of each attribute and the significance value associated with each respective attribute.

48. The system as recited in claim 47, wherein the matching engine is further configured to compute the program score by taking the sum of values derived from multiplying each attribute score by the associated significance value.

49. The system as recited in claim 37, wherein the user preferences in the UPF are defined according to a content description schema.

50. The system as recited in claim 49 wherein the program attributes in the CDF are defined according to the content description schema.

51. A system, comprising:
a preference file that stores preferred program attribute values that a user prefers in programs;
a matching engine configured to compare the preferred program attribute values with program description attribute values that are associated with a program available for viewing by the user, and to recommend the program to the user if the program meets a recommendation standard based on the comparisons.

52. The system as recited in claim 51, wherein the matching engine is further configured to:
calculate a program score based on the comparisons; and
recommend the program if the program score is at least as high as a scoring threshold.

53. The system as recited in claim 52, wherein the matching engine is further configured to calculate the program score by:
assigning an attribute score to each preferred program attribute value that matches a program description attribute value; and
summing the attribute scores to derive the program score.

54. The system as recited in claim 52, wherein the matching engine is further configured to calculate the program score by:
assigning an attribute score to each preferred program attribute value that matches a program description attribute value, the attribute score being an attribute preference rating pre-assigned for the preferred program attribute value; and
deriving a weighted attribute score by factoring a significance value into the attribute score, the significance value identifying a relative importance of the attribute as compared to other program description attribute value; and
summing the weighted attribute scores to derive the program score.

55. The system as recited in claim 51, wherein the preferred program attribute values and the program description attribute values are defined according to a content description schema which provides a standard for describing attributes of programs.

56. The system as recited in claim 51, further comprising a content buffer used to store recommended programs and wherein the matching engine is further configured to stored recommended programs in the content buffer.

57. The system as recited in claim 56, wherein the matching engine is further configured to store a program if there is sufficient buffer space available in the content buffer to store the program.

58. The system as recited in claim 56, wherein the matching engine is further configured to:
determine if there is sufficient buffer storage space available in the content buffer to store the program; and
if there is not sufficient space available to store the program, delete enough stored programs to make space available to store the program if the program is more highly recommended than the stored programs that are deleted, and to store the program in the content buffer.

59. One or more computer-readable media containing electronic representations of:
one or more preferred program attributes, each preferred program attribute identifying an attribute of a multimedia program; and
one or more attribute values associated with each of the preferred program attributes, the attribute values identifying a value preferred by a user to be available in a multimedia program.

60. The one or more computer-readable media as recited in claim 59, further comprising a preference rating associated with each attribute value, each preference rating indicating how much the user likes or dislikes the attribute value.

61. The one or more computer-readable media as recited in claim 60, wherein the preference ratings range from −5 to +5.

62. The one or more computer-readable media as recited in claim 60, wherein the preference ratings range from −3 to +3.

63. The one or more computer-readable media as recited in claim 59, wherein the one or more attribute values conform to a content description schema used to describe content programs.

64. One or more computer-readable media containing computer-executable instructions that, when executed on a computer, perform the following steps:
comparing preferred attribute values that identify program attributes preferred by a user to program attribute values associated with a program available for viewing by the user;
updating a program score associated with the program whenever a match is detected between a program attribute value and a preferred attribute value;
determining whether or not to recommend the program to the user based on the program score.

65. The one or more computer-readable media as recited in claim 64, further comprising instructions to store the program in a content buffer if the determination is made to recommend the program.

66. The one or more computer-readable media as recited in claim 65, further comprising instructions to provide a program description to the user and indicate that the program is recommended if a determination has been made to recommend the program.

67. The one or more computer-readable media as recited in claim 64, further comprising instructions to initialize the program score, a wherein the updating a program score further comprises adding a preference rating associated with the preferred attribute value that matches the program attribute value to the program score when the match is detected.

68. The one or more computer-readable media as recited in claim 67, further comprising instructions to multiply the preference rating for a preferred attribute by a significance value associated with an attribute to which the preferred attribute value corresponds before adding the preference rating to the program score.

69. The one or more computer-readable media as recited in claim 64, wherein the preferred attribute values and the program attribute values conform to a content description schema.

70. One or more computer-readable media containing computer-executable instructions that, when executed on a computer, perform the following steps:
comparing preferred attribute values associated with a user to program attribute values associated with a multimedia program available to a user;
recommending the multimedia program to the user if the comparisons satisfy one or more recommendation condition.

71. The one or more computer-readable media as recited in claim 70, wherein the preference attribute values are maintained in a user preference file (UPF).

72. The one or more computer-readable media as recited in claim 71, wherein the UPF is established with user responses to a UPF questionnaire.

73. The one or more computer-readable media as recited in claim 71, further comprising:
monitoring programs consumed by the user;
generating a user viewing log that outlines program attribute values associated with the consumed programs;
determining new preferred attribute values from the user viewing log; and
updating the UPF with the new preferred attribute values.

74. The one or more computer-readable media as recited in claim 70, wherein the program attribute values are maintained in a content description file that is uniquely associated with the multimedia program.

75. The one or more computer-readable media as recited in claim 70, wherein the preferred attribute values and the program attribute values conform to a content description schema.

76. The one or more computer-readable media as recited in claim 70, wherein the recommending further comprises:
providing a detailed program description of the multimedia program to the user; and
identifying the multimedia program as a recommended program.

77. The one or more computer-readable media as recited in claim 70, wherein the recommending further comprises storing the multimedia program in a content buffer that stores recommended programs if the multimedia program is recommended to the user, if there is sufficient memory available in the content buffer to store the multimedia program.

78. The one or more computer-readable media as recited in claim 77, further comprising:
computing a program score for the multimedia program based on the comparisons;
if the content buffer does not contain sufficient available memory to store the multimedia program in the content buffer, comparing the program score for the multimedia program with program scores for each of one or more stored programs contained in the content buffer;
deleting one or more stored programs that have program scores lower than the program score of the multimedia program to free sufficient storage space in the content buffer to store the multimedia program; and
storing the multimedia program in the content buffer.

79. The one or more computer-readable media as recited in claim 70, further comprising:
determining a preference rating for each attribute for which a preferred attribute value matches a program attribute value;
summing the preference ratings determined to derive a program score; and
wherein the recommendation condition is related to the program score.

80. The one or more computer-readable media as recited in claim 79, further comprising weighting each preference rating with a significance value associated with the attribute associated with the preference rating, the significance value identifying a relative importance of the attribute as compared to other attributes, said weighting performed prior to summing the preference ratings.

81. The one or more computer-readable media as recited in claim 70, wherein the multimedia program is a television program.

82. The one or more computer-readable media as recited in claim 70, wherein the multimedia program is an audio program.
